(19) United States
(12) Patent Application Publication
(10) Pub. No.: US 2007/0241275 A1
(43) Pub. Date: Oct. 18, 2007

(54) Neutron source for well logging

(75) Inventors: Pingjun Guo, Pearland, TX (US); Detlef Hahn, Hannover (DE)

Correspondence Address: MADAN, MOSSMAN & SRIRAM, P.C., 2603 AUGUSTA DRIVE, SUITE 700, HOUSTON, TX, 77057-5662, US

(73) Assignee: Baker Hughes Incorporated

(21) Appl. No.: 11/247,684

(22) Filed: Oct. 11, 2005

(51) Int. Cl. G01V 5/08

(52) U.S. Cl. 250/269.1

(57) ABSTRACT

A neutron source for a downhole logging tool includes ²⁴¹Am and ⁹Be. Stainless steel shielding is used to control the generation of neutrons by the source. The device may be used for both continuous as well as pulsed neutron logging and may also be used for gamma ray logging.

### BACKGROUND OF THE INVENTION

This invention relates generally to oil and gas well logging tools. More particularly, this invention relates tools for measuring rock formation porosity and/or density through the use of neutrons and gamma rays generated by a controllable chemical neutron source.

In petroleum and hydrocarbon production, it is desirable to know the porosity of the subterranean formation which contains the hydrocarbon reserves. Knowledge of porosity is essential in calculating the oil saturation and thus the volume of oil in-place within the reservoir. Knowledge of porosity is particularly useful in older oil wells where porosity information is either insufficient or nonexistent to determine the remaining in-place oil and to determine whether sufficient oil exists to justify applying enhanced recovery methods. Porosity information is also helpful in identifying up-hole gas zones and differentiating between low porosity liquid and gas. If the density of the formation is known, then porosity can be determined using known equations. A variety of tools exist which allow the density of the reservoir to be determined.

Neutron porosity well logging instruments are used primarily to determine the volumetric concentration of hydrogen nuclei within earth formations. The volumetric concentration of hydrogen nuclei is a parameter of interest because it is generally related to the fractional volume of pore space (referred to as the “porosity”) of the earth formations. Fluids typically present in the pore spaces of earth formations include water and/or some mixtures of petroleum compounds. Water and petroleum compounds include chemically combined hydrogen. Indications of high volumetric concentrations of hydrogen, therefore, typically correspond to high fractional volumes of fluid-filled pore space (“porosity”). High porosity typically corresponds to earth formations which are capable of producing commercial quantities of materials such as petroleum.

Neutron porosity well logging instruments known in the art include so-called “compensated” thermal neutron instruments. Compensated thermal neutron instruments generally have two or more detectors sensitive to thermal neutrons. The detectors are positioned at spaced apart locations from a source of high energy neutrons. The neutron source is typically a so-called “steady-state” or “chemical” source which emits substantially continuous numbers of high-energy neutrons. Steady-state neutron sources used for thermal neutron porosity well logging include radioisotopes such as americium-241 disposed inside a beryllium “blanket”. The neutrons emanating from this type of steady-state source have an average energy of about 4.5 million electron volts (MeV). The detectors can include helium-3 gas ionization tubes (also called helium proportional counters) which are particularly sensitive to neutrons at the thermal energy level, generally considered to be a most probable energy of about 0.025 electron volts (eV). For other applications in which gamma rays resulting from inelastic scattering of the neutrons are measured, detectors such as sodium iodide (in conjunction with photomultiplier tubes) may be used.

In determining porosity using a compensated thermal neutron instrument, the high energy neutrons emitted from the steady-state source travel into the earth formations where they gradually lose energy, primarily by collision with hydrogen nuclei within the earth formations. As the neutrons are reduced in energy to the thermal level they can be detected by either of the detectors. Compensated thermal neutron instruments are typically configured so that the numbers of neutrons detected by each of the detectors (the “count rate” at each detector) are scaled into a ratio of count rates. The ratio is typically the count rate of the detector closer to the source (the “near” detector) with respect to the count rate of the more spaced apart (“far”) detector. The count rate ratio can be further scaled, by methods well known in the art, into a measurement corresponding to formation porosity. The pore spaces are assumed to be filled with fresh water in scaling the ratio into porosity. Alternatively, the ratio can be scaled into volumetric hydrogen concentration (the so-called “hydrogen index”). Scaled ratio measurements are typically referred to for the sake of convenience as the “neutron porosity” of the earth formations, and more specifically are referred to as the “thermal neutron porosity” when made with a compensated thermal neutron instrument.

A particular drawback to the compensated thermal neutron instruments known in the art is that they use steady-state (chemical) neutron sources. Chemical neutron sources emit neutrons at all times and expose the system operator to some neutron radiation until the instrument is lowered into the wellbore. For safety reasons it would be preferable to have a thermal neutron porosity instrument which is substantially non-radioactive until it is inserted into the wellbore.

Another drawback to chemical neutron sources is that they have relatively low neutron output, at least in part intentionally so that the instrument may be used relatively safely by the system operator. The statistical precision of thermal neutron porosity logs could be improved if the neutron output could be increased, but the strength of the steady state source is generally limited by such safety considerations.

To address some of the safety problems posed by chemical neutron, accelerator neutron sources have been used. An example of such an accelerator based neutron source using the deuterium-tritium (D-T) reaction is disclosed in U.S. Pat. No. 5,789,752 to Michael. The neutrons produced by such a source have an energy of 14 MeV or so.

Accelerator neutron sources are complex in design and require a lot of power to operate. This is a major concern in logging-while-drilling sondes that rely solely on battery power. Other concerns are cost and reliability. For certain neutron measurements such as neutron porosity measurement, 14-MeV accelerator neutron sources do not possess the same formation porosity sensitivity as the chemical neutron sources in which neutrons with average energy of 4.5 MeV are produced. In addition, accelerator sources produce variable neutron outputs and are difficult to regulate, making calibration of the sources difficult. Neutron outputs from chemical neutron sources, on the other hand, can be accurately calibrated due to their long half-lives.

It would be desirable to have a neutron source for downhole use that addresses the safety problems posed by prior art chemical sources while retaining the advantages of stability of chemical sources. The present invention addresses this need.

### SUMMARY OF THE INVENTION

One embodiment of the invention is an apparatus for evaluating an earth formation. The apparatus includes a tool conveyed in a borehole in the earth formation and a radiation source on the tool which controllably emits radiation into the formation. The radiation source includes a source of alpha particles, a target material that emits the radiation when targeted by the alpha particles, and a mechanical device which controllably shields the target material from the alpha particles. The apparatus also includes at least one detector spaced apart from the source which detects radiation resulting from interaction of the emitted radiation with the earth formation. The source of alpha particles may be ²⁴¹Am, ²³⁹Pu, ²¹⁰Po, ²⁴⁴Cm, and/or ²²⁶Rn. The emitted radiation may consist of neutrons and/or gamma rays. The target material may include ⁹Be, ¹⁰B, ¹³C, ⁷Li, and/or ¹⁹F. The mechanical device may include a shielding material which absorbs the alpha particles and a motor which moves a piece of the source material into the immediate proximity of the target material. The motor may be a reciprocating linear motor. The shielding material may be stainless steel. The mechanical device may include a first slotted shield and a second slotted shield interposed between the source and the target and a motor which produces relative motion between the first and second slotted shields. The slots may be parallel to or orthogonal to an axis of the tool. The mechanical device may include a spring-mass system. The controllable motion may be linear or rotary. A processor may determine from the detected radiation a formation density, a formation porosity and/or an elemental composition of the formation. The apparatus may include a conveyance such as a wireline, a drilling tubular or a slickline. The detector may be a neutron detector or a gamma ray detector.

Another embodiment of the invention is a method of evaluating an earth formation. A tool having a source of alpha particles and a target material is conveyed into a borehole. Radiation is emitted into the formation by controllably shielding the target material from alpha particles. Radiation resulting from interaction of the emitted radiation with the earth formation is detected at at least one location spaced apart from the source of alpha particles. The source of alpha particles may be ²⁴¹Am, ²³⁹Pu, ²¹⁰Po, ²⁴⁴Cm, and/or ²²⁶Rn. The emitted radiation may include neutrons and/or gamma rays. The target material may include ⁹Be, ¹⁰B, ¹³C, ⁷Li, and/or ¹⁹F. The controllable shielding may involve use of a shielding material which absorbs the alpha particles and moving a piece of the source material into the immediate proximity of the target material. Moving of the source material may be done using a reciprocating linear motor. Stainless steel may be used as the shielding material. The controllable shielding may also be done by interposing first and second slotted shields between the source and the target and by moving the shields relative to each other. Slots that are parallel to or orthogonal to the tool axis may be used. The relative motion may be accomplished using a spring-mass system. The movement may be linear or rotary. From the detected radiation, the formation density, formation porosity and/or elemental composition of the formation may be determined. The tool may be conveyed into the borehole on a wireline, a drilling tubular or a slickline. The radiation that is detected may be gamma rayes and or neutrons.

Another embodiment of the invention is a computer readable medium for use with an apparatus for evaluating an earth formation. The apparatus includes a tool conveyed in a borehole in the earth formation and a radiation source on the tool which controllably emits radiation into the formation. The radiation source includes a source of alpha particles, a target material that emits the radiation when targeted with the alpha particles, and a mechanical device which controllably blocks the alpha particles from targeting the target material. The apparatus also includes at least one detector spaced apart from the source which radiation resulting from interaction of the emitted radiation with the earth formation. The medium includes instructions which enable a processor to determine from the detected radiation at least one of (i) a density of the formation, (ii) a porosity of the formation, and (iii) an elemental composition of the formation. The medium may include a ROM, an EPROM, am EEPROM, a flash memory, and/or an optical disk.

### BRIEF DESCRIPTION OF THE FIGURES

The present invention is best understood with reference to the accompanying figures in which like numerals refer to like elements and in which:

FIG. 1 (prior art) is an overall schematic diagram of the nuclear well logging system suitable for use with the present invention;

FIG. 2 (prior art) illustrates the generation of gamma rays by inelastic scattering and capture of thermal and epithermal neutrons;

FIGS. 3a, 3b are schematic illustrations of the neutron source of one embodiment of the invention in the engaged and disengaged positions;

FIGS. 4a, 4b are schematic cross sections of the neutron source of another embodiment of the invention using rotary movement;

FIG. 5 is an isometric view of the device of FIGS. 4a, 4b;

FIG. 6 is the spectrum of a neutron source using ²⁴¹Am and ⁹Be;

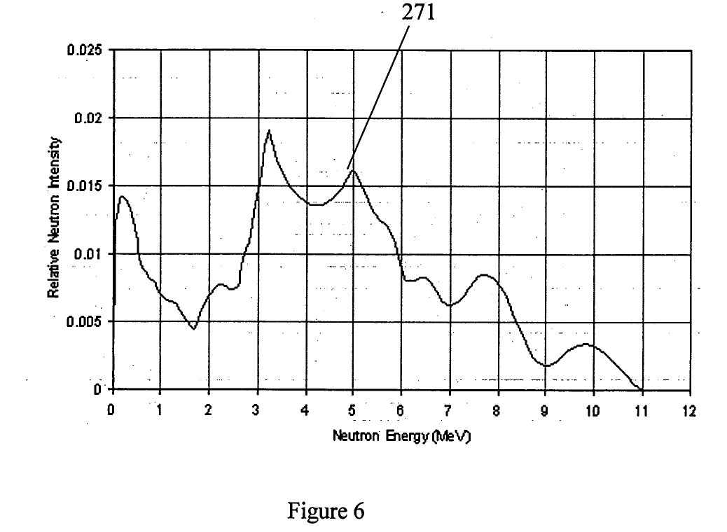

FIG. 7a is a schematic illustration of neutron flux that would be obtained with the device of FIGS. 4a and 4b using a motor with constant speed;

FIG. 7b is a schematic illustration of neutron flux that would be obtained with the device of FIGS. 4a, 4b using oscillatory motion;

FIG. 8 is a schematic illustration of a pulsed source using linear motion;

FIG. 9 is a schematic illustration of a thermal neutron porosity instrument;

FIG. 10 shows the response characteristics of a neutron porosity tools having AmBe source and one having a 14 MeV DT source; and

FIG. 11 is a schematic illustration of a novel tool having a controllable radiation source and neutron and gamma ray detectors.

### DETAILED DESCRIPTION OF THE INVENTION

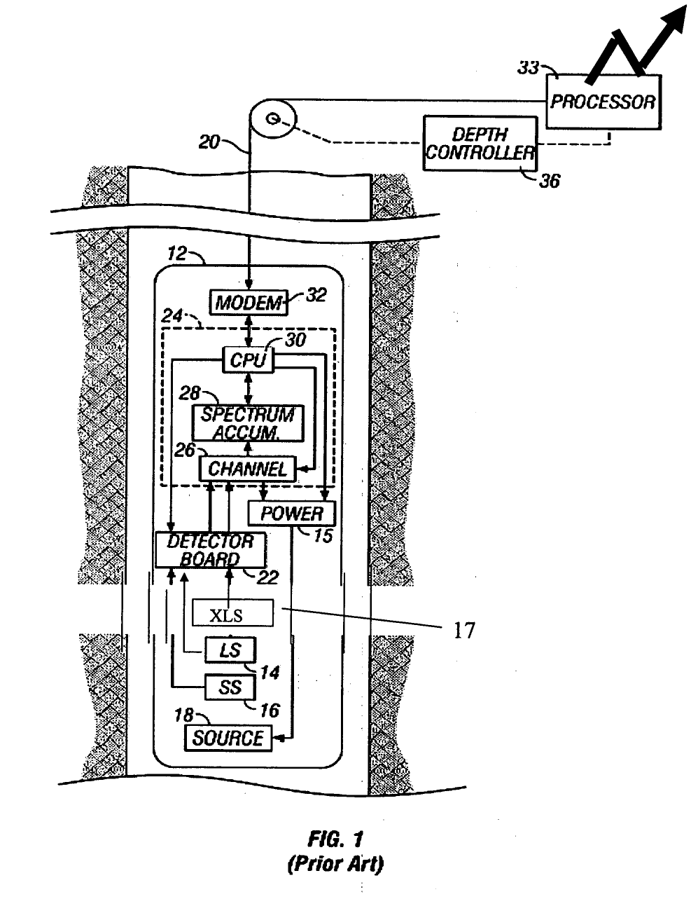

The system shown in FIG. 1 is a system for logging that may be used with the present invention. Well 10 penetrates the earth's surface and may or may not be cased depending upon the particular well being investigated. Disposed within well 10 is subsurface well logging instrument 12. The system diagramed in FIG. 1 is a microprocessor-based nuclear well logging system using multi-channel scale analysis for determining the timing distributions of the detected gamma rays. Well logging instrument 12 includes an extra-long spaced (XLS) detector 17, a long-spaced (LS) detector 14, a short-spaced (SS) detector 16 and pulsed neutron source 18. In one embodiment of the invention, XLS, LS and SS detectors 17, 14 and 16 are comprised of suitable material such as bismuth-germanate (BGO) crystals or sodium iodide (NaI) coupled to photomultiplier tubes. To protect the detector systems from the high temperatures encountered in boreholes, the detector system may be mounted in a Dewar-type flask. This particular source and flask arrangement is an example only, and should not be considered a limitation. Also, in one embodiment of the invention, source 18 comprises a neutron source described below that uses Americium/Beryllium for generation of neutrons. As described below, the source may be operated in either a continuous mode or in a pulsed mode. This particular type of source is for exemplary purposes only and not to be construed as a limitation. Power supply 15 is used for providing the necessary power to the source. Cable 20 suspends instrument 12 in well 10 and contains the required conductors for electrically connecting instrument 12 with the surface apparatus.

The outputs from XLX, LS and SS detectors 17, 144 and 16 are coupled to detector board 22, which amplifies these outputs and compares them to an adjustable discriminator level for passage to channel generator 26. Channel generator 26 (optional) is a component of multi-channel scale (MCS) section 24 which further includes spectrum accumulator 28 and central processor unit (CPU) 30. MCS section 24 accumulates spectral data in spectrum accumulator 28 by using a channel number generated by channel generator 26 and associated with a pulse as an address for a memory location. After all of the channels have had their data accumulated, CPU 30 reads the spectrum, or collection of data from all of the channels, and sends the data to modem 32 which is coupled to cable 20 for transmission of the data over a communication link to the surface apparatus. Channel generator 26 also generates synchronization signals which control the pulse frequency of source 18, and further functions of CPU 30 in communicating control commands which define certain operational parameters of instrument 12 including the discriminator levels of detector board 22, and the filament current and accelerator voltage supplied to source 18 by power supply 15. The use of the channel generator and the recording of data from the individual channels is specific to the use of the source in a pulsed mode. In the continuous mode of operation of the source, no time domain analysis of the data is done, only a spectral analysis.

The surface apparatus includes master controller 34 coupled to cable 20 for recovery of data from instrument 12 and for transmitting command signals to instrument 12. There is also associated with the surface apparatus depth controller 36 which provides signals to master controller 34 indicating the movement of instrument 12 within well 10. The system operator accesses the master controller 34 to allow the system operator to provide selected input for the logging operation to be performed by the system. Display unit 40 and mass storage unit 44 are also coupled to master controller 34. The primary purpose of display unit 40 is to provide visual indications of the generated logging data as well as systems operations data. Storage unit 44 is provided for storing logging data generated by the system as well as for retrieval of stored data and system operation programs. A satellite link may be provided to send data and or receive instructions from a remote location.

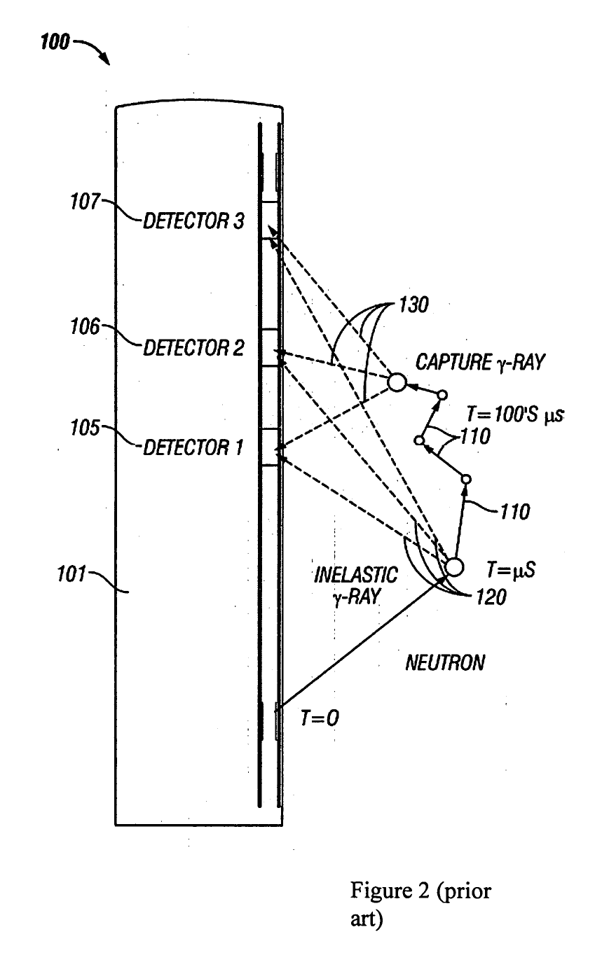

In a well logging operation such as is illustrated by FIG. 1, master controller 34 initially transmits system operation programs and command signals to be implemented by CPU 30, such programs and signals being related to the particular well logging operation. Instrument 12 is then caused to traverse well 10 in a conventional manner, with source 18 being pulsed in response to synchronization signals from channel generator 26. In the pulsed mode of operation, the source 18 may pulsed at a rate of up to 1000 bursts/second (1 KHz). This, in turn, causes a burst of high energy neutrons on the order of 4.5 MeV to be introduced into the surrounding formation to be investigated. As discussed below with reference to FIG. 2, this population of high energy neutrons introduced into the formation will cause the generation of gamma rays within the formation which at various times will impinge on XLS, LS and SS detectors 17, 14 and 16. As each gamma ray thus impinges upon the crystal-photomultiplier tube arrangement of the detectors, a voltage pulse having an amplitude related to the energy of the particular gamma ray is delivered to detector board 22. It will be recalled that detector board 22 amplifies each pulse and compares them to an adjustable discriminator level, typically set at a value corresponding to approximately 100 KeV. If such pulse has an amplitude corresponding to an energy of at least approximately 100 KeV, the voltage pulse is transformed into a digital signal and passed to channel generator 26 of MCS section 24.

In addition, as would be known to those versed in the art, many of the functions of the components described with reference to FIG. 1 may be carried out by a processor. It should also be noted that the system described in FIG. 1 involves conveyance of the logging device into the well by a wireline. However, it is envisaged that the logging device could be part of a measurement while drilling (MWD) bottom hole assembly conveyed into the borehole by a drilling tubular such as a drillstring or coiled tubing. In addition, it should be noted that FIG. 1 illustrates a tool in an open hole. The method and apparatus are equally well suited for use in cased holes.

FIG. 2 shows an illustration of the logging tool suitable for use with the present invention. The apparatus illustrated is that of the Reservoir Performance Monitor (RPM) of Baker Atlas, Incorporated. A measurement device 100 comprises a neutron source 101 and three axially spaced apart detectors described below. The number of detectors shown in the embodiment of FIG. 2 is only an example of the number of detectors employed in an embodiment of the present invention. It is not a limitation on the scope of the present invention. Some aspects of the present invention can be implemented with a single detector. The neutron source 101 may be pulsed at different frequencies and modes for different types of measurements. The short-spaced (SS) detector 105 is closest to the source 101 The long-spaced (LS) detector is denoted by 106, and the furthest detector 107 is referred to as the extra-large spaced (XLS) detector. Neutrons are emitted from the source 101 and enter the borehole and formation, where they undergo several types of interactions. During the first few microseconds (μs), before they lose much energy, some neutrons are involved in inelastic scattering with nuclei in the borehole and formation and produce gamma rays. These inelastic gamma rays 120, have energies that are characteristic of the atomic nuclei that produced them. The atomic nuclei found in this environment include, for example, carbon, oxygen, silicon, calcium, and some others.

One or more gamma-ray detectors may be employed, in one or more modes of operation. Such modes include, but are not limited to, a pulsed neutron capture mode, a pulsed neutron spectrometry mode, a pulsed neutron holdup imager mode, and a neutron activation mode. In a pulsed neutron capture mode, for example, the tool pulses at 1 kHz, and records a complete time spectrum for each detector. An energy spectrum is also recorded for maintaining energy discrimination levels. Time spectra from short-spaced and long-spaced detectors can be processed individually to provide traditional thermal neutron capture cross section information, or the two spectra can be used together to automatically correct for borehole and diffusion effects and produce results substantially approximating intrinsic formation values.

In a pulsed neutron spectrometry mode, prior art instruments typically pulse at 10 kHz, and records full inelastic and capture gamma ray energy spectra from each detector. These data are processed to determine critical elemental ratios including carbon/oxygen and calcium/silicon from the inelastic spectra and silicon/calcium from the capture spectra. A pulsed neutron holdup imager mode yields both energy spectra and time decay spectra from each detector simultaneously. Measurements can be used to determine holdups of gas, oil, and water. When combined with other production logs, the measurements made herein can provide a comprehensive production profile picture, even in deviated or horizontal wells. A neutron activation mode provides water-flow measurements using one of several data acquisition methods. Stationary measurements are made in either of two modes, and measurements at different logging speeds can be used to segregate different flow rates in either an annulus or in an adjacent tubing string. Various spectra of count rates from these can be used either individually or in combination as needed for each measurement mode.

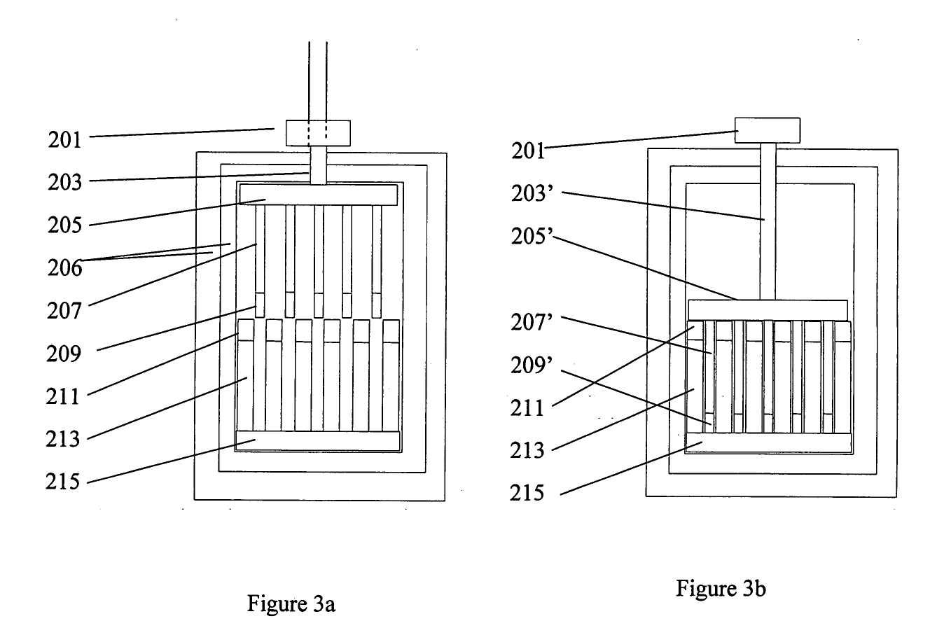

The configuration of the source 18 in one embodiment of the invention is shown in detail in FIGS. 3a and 3b. Shown in FIG. 3a is a containment vessel 206 that may be made of a material such as stainless steel. Positioned within the containment vessel is a base plate 215 which supports a neutron emitting material such as Beryllium (⁹Be) 213. The Be is topped with stainless steel 211. The Beryllium/stainless steel may be machined in the form of two coupled blocks and provided with holes. Also shown in FIG. 3a is a support plate 205 which carries rods 207 of material such as Americium 241 (²⁴¹Am) that are also tipped with stainless steel 209.

The support plate 205 may be moved by a control rod 203 to the position 203′ shown in FIG. 3b. This position is referred to as the “engaged” position, in contrast to the disengaged position of FIG. 3a. The movement of the control rod 203 may be done by a suitable controller 201. As can be seen in FIG. 3b, with the support plate in the engaged position, the ²⁴¹Am 207′ is juxtaposed against the ⁹Be 211. With this juxtaposition, alpha particles emitted by the ²⁴¹Am interact with the ⁹Be to produce fast neutrons according to
⁹Be+α→₁₂C+n+5.71 MeV (1).
These fast neutrons form radiation that is emitted into the formation. With the ²⁴¹Am 207 in the position of FIG. 3a, the alpha particles emitted by the ²⁴¹Am are absorbed by the stainless steel tips 209 before they can interact with the ⁹Be. Consequently, with the source in the disengaged position, it is possible to deploy the logging tool in a downhole position with relative safety: the alpha particles emitted by the ²⁴¹Am are absorbed by the stainless steel, and neutrons are not produced by the ⁹Be since there is no radiation by alpha particles of the ⁹Be to produce the neutrons in accordance with eqn. (1). It should be noted that the geometry of the ²⁴¹Am and the ⁹Be (rods within cylindrical cavities) is for illustrative purposes only. Other configurations could be used, such as interleaved plates. What is important is (i) a first configuration in which alpha particles emitted by the ²⁴¹Am do not interact with the ⁹Be, and (ii) a second configuration in which alpha particles emitted by the ²⁴¹Am do interact with the ⁹Be, and (iii) the ability to make a transition between the first configuration to the second configuration. In the embodiment illustrated in FIGS. 3a, 3b, the transition is accomplished by physically moving the ²⁴¹Am relative to the ⁹Be.

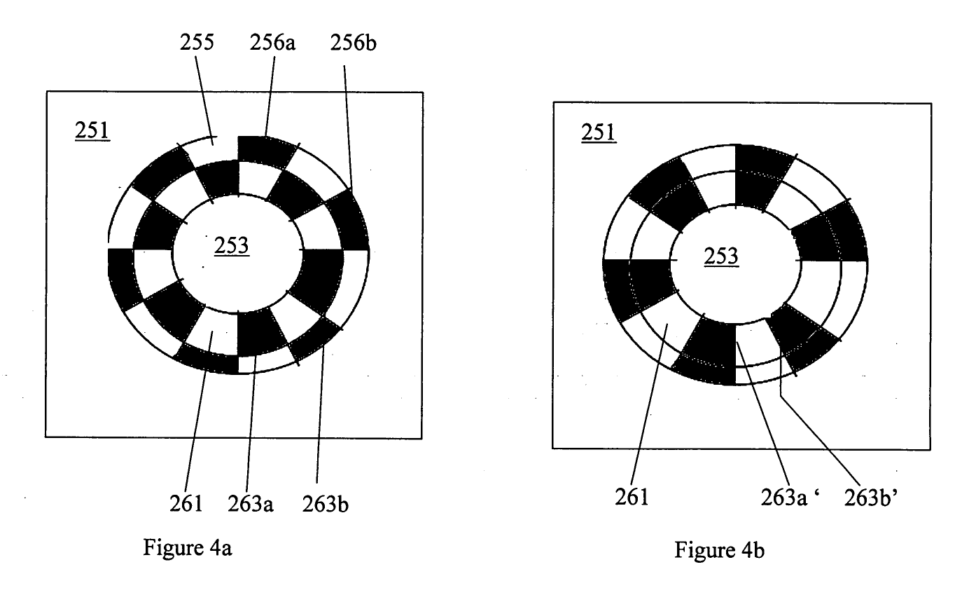

In an alternate embodiment of the invention, the transition from the first configuration to the second configuration is accomplished by moving the stainless steel shield. This is illustrated in FIGS. 4a, 4b. Shown in cross-sectional view therein is an arrangement in which ²⁴¹Am (denoted by 253 for illustrative purposes) is positioned inside a block 251 of ⁹Be. Separating the alpha emitter 253 from the neutron emitter 251 are a pair of concentric stainless steel shields 255 and 261. Shield 255 has a plurality of vertical slots denoted by 256a, 256b . . . while shield 261 also has a plurality of vertical slots 263a, 263b. In the configuration shown in FIG. 4a, the ⁹Be is effectively completely shielded from the alpha radiation from the ²⁴¹Am.

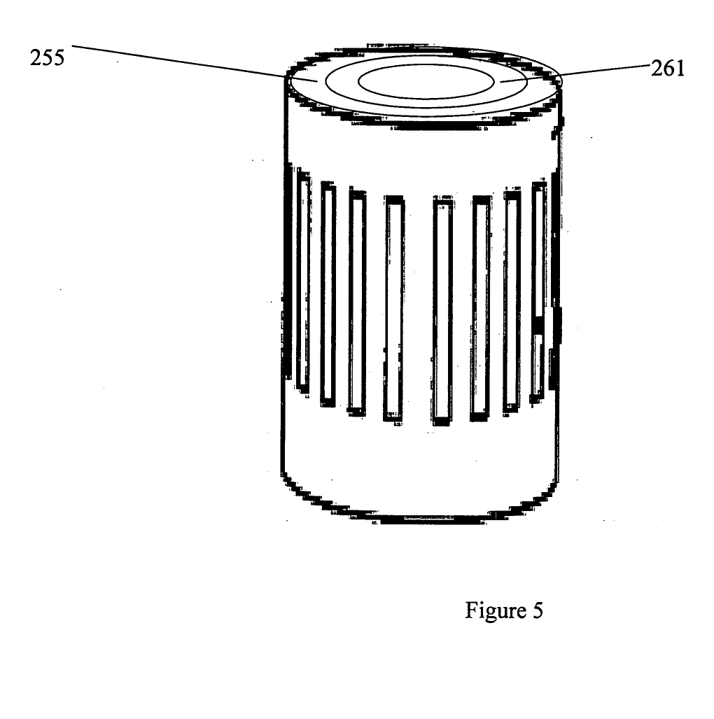

When the two stainless steel shields are rotated relative to each other to the configuration shown in FIG. 4b, the slots on the two shields line up, so that the ⁹Be is irradiated with alpha particles from the ²⁴¹Am, thus generating energetic neutrons that can be used for formation evaluation. FIG. 5 shows an isometric view of the source shown in FIGS. 4a, 4b.

It should be noted that in FIGS. 4a, 4b, only six slots are shown. This is to simplify the illustration: in practice, a much larger number of slots may be used. It is clear that with six slots, each slot would be 30° in extent. With an increased number of slots, for example, 36 slots, each slot would be 5° in extent. This makes it possible to use the device of FIGS. 4a, 4b as a pulsed neutron source as described next.

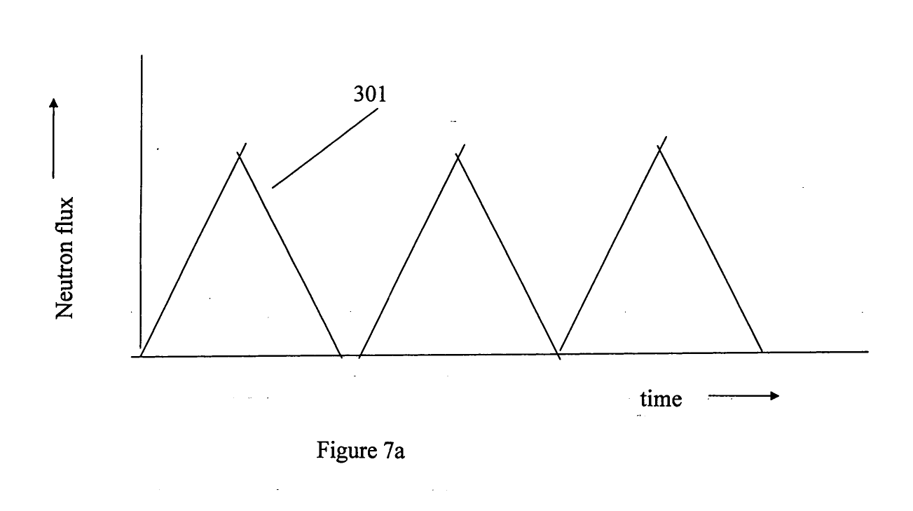

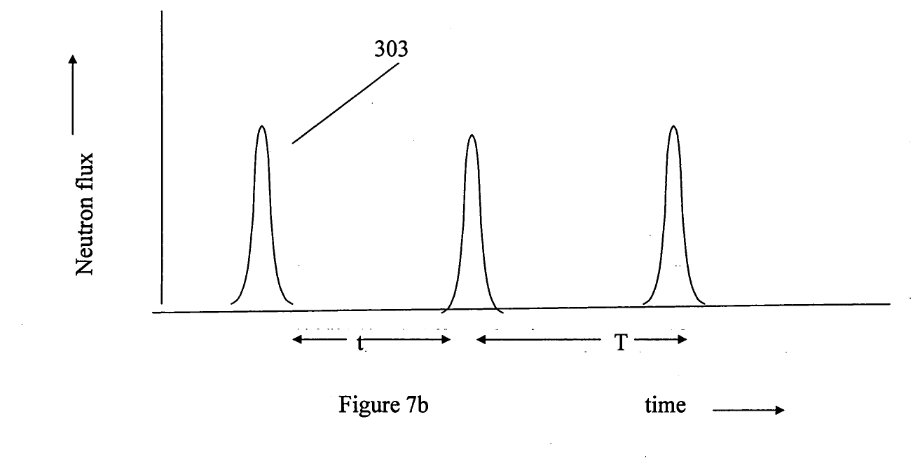

To operate the device of FIGS. 4a, 4b as a pulsed neutron source, relative rotation between the stainless steel cylinders may be accomplished using a suitable motor. FIG. 7 shows the neutron flux 301 produced by the device of FIGS. 4a, 4b in the hypothetical case when the two cylinders rotate at constant relative speed. The peaks correspond to the times when the two sets of slots are aligned and the zeros correspond to the times when the slots on the two cylinders are midway relative to each other. With the use of a spring-mass system (not shown), relative oscillatory motion of the shields is possible. By suitable design of the oscillatory system, it is possible to have the slots aligned for a small portion of the period of oscillation. This may be done, for example, by having slots that are 5° wide and the amplitude of the oscillations equal to 15°. This is schematically illustrated by 303 in FIG. 7b. If the oscillations are depicted by a simple harmonic motion of amplitude A and the half width of the slot is a, then the neutron flux will be zero for a fraction of t/T (see FIG. 7b) the cycle time given by

$$\frac{t}{T} = \frac{{Sin}^{- 1} ( 1 - a / A )}{π} . \qquad ( 2 )$$

By having the source active for a relatively short time, the detected signals require less correction for the direct flux from the source.

The basic principles of producing rotational oscillatory motion using a spring mass system are described in U.S. Pat. No. 6,626,253 to Hahn et al, having the same assignee as the present invention and the contents of which are fully incorporated herein by reference. Disclosed therein is a drive system for an oscillating shear valve which has a rotor and a stator with the same basic configuration as in FIGS. 4a, 4b. It should be noted that the system described in Hahn is capable of operation at 40 Hz with an oscillation angle of 12°: extension to the present case is straightforward as the power requirements are roughly proportional to the oscillating mass and to the square of the oscillation angle.

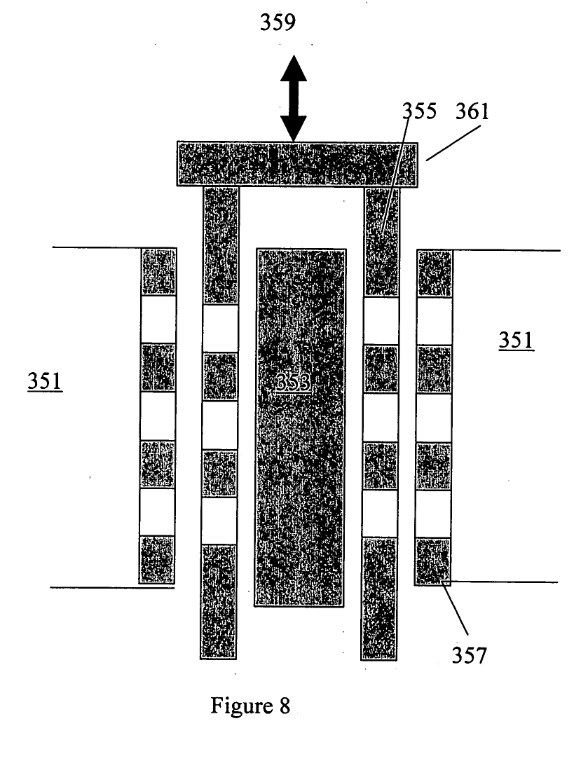

In another embodiment of the invention, a instead of vertical slots, the shields may be provided with horizontal slots and a linear drive motor may be used. A possible implementation is shown in FIG. 8. Shown therein are the alpha particle source ²⁴¹Am 353 surrounded by the target ⁹Be 353. In the particular implementation shown, a slotted stainless steel shield 357 may be attached to the target. A second slotted stainless steel shield 355 is interposed between the source 353 and the shield 357. A plate 361 supporting the shield 355 may be moved as indicated by the arrow 359. This movement will expose and shield the target from the alpha particles depending upon the relative positions of the slots. Typically, the vertical extent of the alpha particle source is of the order of 5 cm. The slotted arrangement makes it possible to pulse the neutron flux at high frequencies, something that would be impractical if vertical motion of 5 cm. were required.

The basic principles of using a linear electric motor for reciprocating motion are discussed, for example, in U.S. Pat. No. 6,898,150 to Hahn et al having the same assignee as the present invention and the contents of which are incorporated herein by reference. Again, with a spring-mass system, practical designs with a pulse rate of 1 kHz or higher are possible.

Those versed in the art would recognize that materials other than ²⁴¹Am could be used as a source of alpha particles. Specifically, most of the actinides, including ²³⁹Pu, ²¹⁰Po, ²⁴⁴Cm and ²²⁶Rn could be used. The decay process of heavy nuclei such as actinides that emit alpha particles is written as

$${}_{Z}^{A} X \to {}_{z - 2}^{A - 4} Y + {}_{2}^{4} α$$

Materials other than ⁹Be could be used as targets for the alpha particles. These include ¹⁰B, ¹³C, ⁷Li, and ¹⁹F

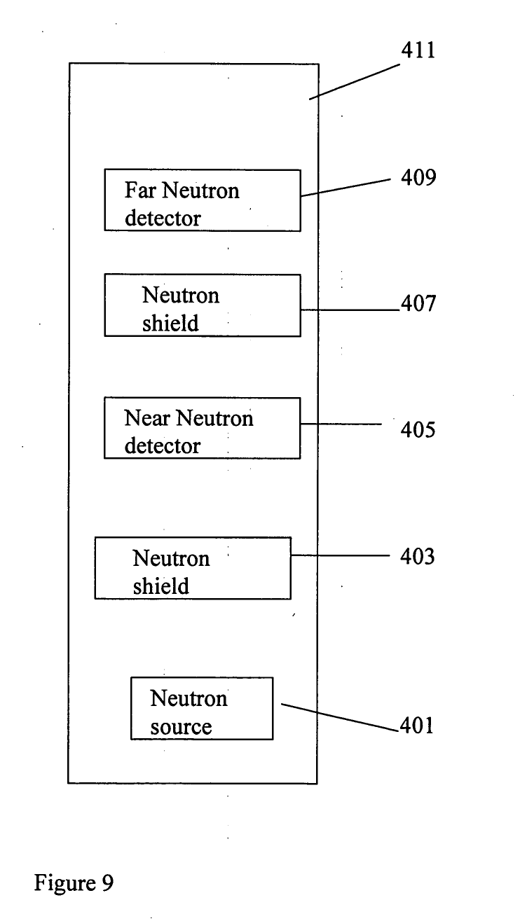

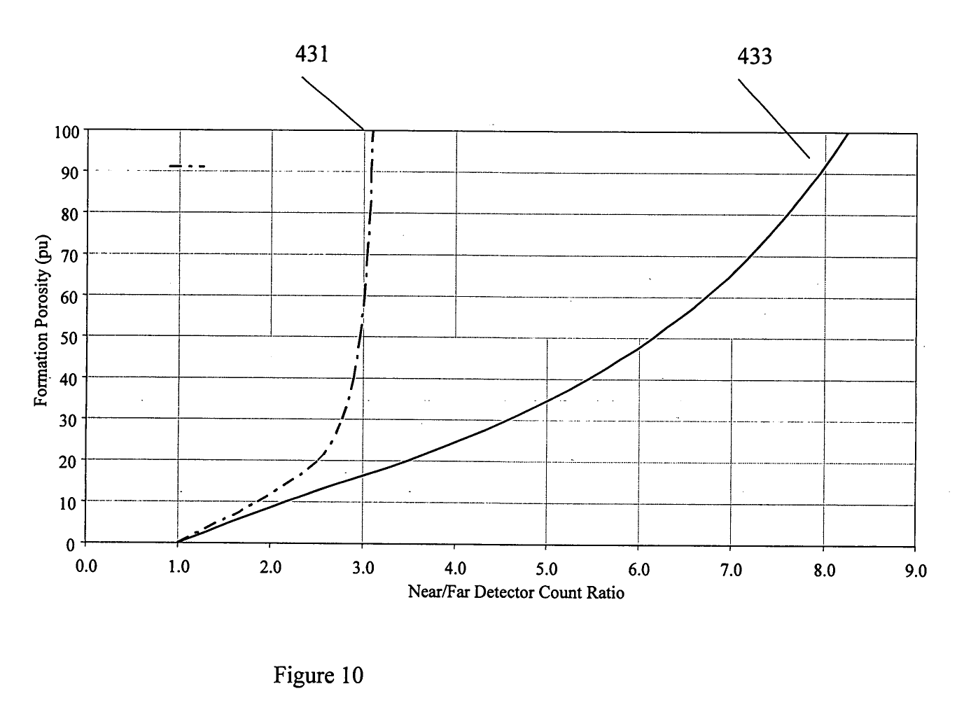

Prior art neutron porosity measurements typically typically have the configuration shown in FIG. 9. The tool 411 includes a neutron source 401, at least two neutron detectors 405, 409 and neutron shields 403, 407 that shield the detectors from the direct flux of neutrons from the source. The ratio of counts at the near to the far detector are commonly used for neutron porosity determination. This is illustrated in FIG. 10 where the abscissa is the ratio and the ordinate is the formation porosity for limestone. The curve 433 gives the relation (obtained by calibration for a particular tool) between the near/far ratio and the porosity when an AmBe source is used. For safety reasons, the AmBe source has not been preferred for use in recent years and pulsed neutron sources have been used. The curve 431 gives the relation between the near/far ratio for a pulsed neutron source using a 14 MeV DT source . As can be seen, once in mid and high porosity formations, the nar/far ratio for a tool having a pulsed neutron source is insensitive to changes in porosity. One embodiment of the present invention uses the same basic configuration of FIG. 9 but has the controllable (possibly pulsed) source described above.

The invention has been described above in terms of a neutron source that may be controllable to produce pulses of neutrons. The same principles can also be used to provide a controllable gamma ray source. This is described next. Specifically, alpha particles produced by the actinides can be used as a source of gamma rays as well. These embodiments of the invention may be based on the following reactions:

$${}_{4}^{9} Be + {}_{2}^{4} α \to {}_{6}^{12}{C}{}_{}^{*} + {}_{0}^{1} n + 5.71 MeV \\ {}_{6}^{12}{C}{}_{}^{*} \to {}_{6}^{12} C + ( 4.44 MeV ) γ . \qquad ( 3 )$$

The first of eqns. (3) is the same as eqn. (1). The * indicates that the resulting Carbon nucleus is unstable and decays almost instantaneously to a stable Carbon nucleus with the emission of a gamma ray of 4.44 MeV (given by the second of equations 3). Thus, the combination of a Beryllium target with a source of alpha particles is a source of both neutrons and of gamma rays. The radiation that is emitted into the formation by the AmBe source can thus include neutrons as well as gamma rays. Thus, the mechanical arrangement described above can be used not only as a controllable source of neutrons but also as a controllable source of gamma rays.

Another reaction that is of interest uses Carbon as the target and is given by:

$${}_{6}^{13} C + {}_{2}^{4} α \to {}_{8}^{16}{O}{}_{}^{*} + {}_{1}^{0} n \\ {}_{8}^{16}{O}{}_{}^{*} \to {}_{8}^{16} O + ( 6.310 MeV ) γ . \qquad ( 4 )$$

Thus, the source described above can be used to generate monoenergetic gamma rays. These monoenergetic gamma rays can be used for a variety of downhole measurements, including formation density measurements.

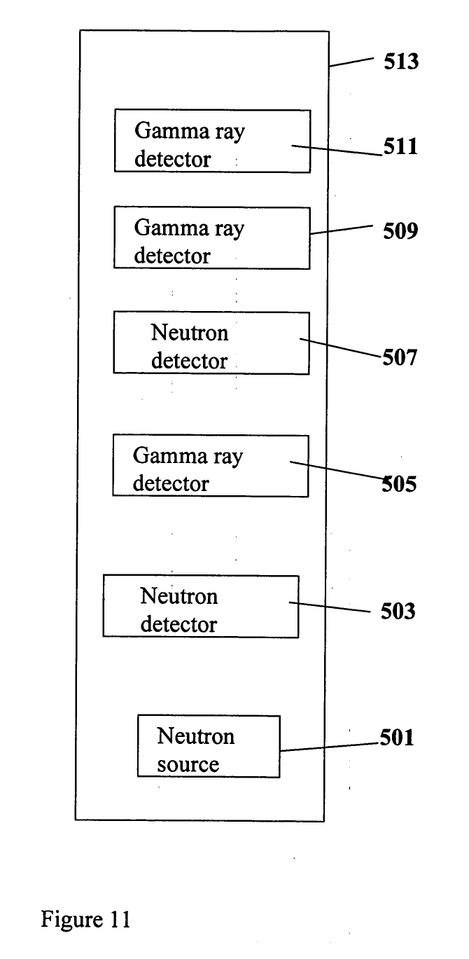

Turning now to FIG. 11, a novel instrument 513 that uses a controllable radiation source and a plurality of detectors of different types is illustrated. Shown therein is the controllable source 501 described above which can be used as a source of gamma rays and neutrons. Neutron detectors are indicated by 503, 507 while exemplary gamma ray detectors are indicated by 505, 509, 511. The number of detectors shown therein is for exemplary purposes only and is not to be construed as a limitation to the invention. To simplify the illustration, shields in the logging tool which block the emitted radiation from directly reaching the detectors are not shown.

Using the novel source described above, a variety of data pertaining to formation properties can be obtained. Using prior art methods, the gathered data can be used to estimate formation density, formation porosity, and elemental analysis of the earth formation. The elements that can be readily measured from the capture gamma ray energy spectrum comprise Ca, Cl, H, Fe, Mg, Si, and S. The elements that can be readily measured from the inelastic gamma ray energy spectrum comprise C, Ca, Fe, Mg, O, Si, Al and S. The list is not intended to be complete and other elements could also be identified.

The processing of the data may be done by a surface or a downhole processor. In the case of MWD measurements (in which the logging instrument is conveyed downhole by a drilling tubular on a bottomhole assembly), processing is preferably done by a downhole processor to reduce the amount of data that has to be telemetered to the surface. In any case, the relationships used for density estimation may be determined ahead of time and used by the processor. As noted above, in one embodiment of the invention, the relationships may be derived from logs made in open-hole with dual receivers and a chemical gamma ray source. The relationships may also be derived using Monte-Carlo simulation for a variety of borehole, casing and cement conditions. Such simulations have been described, for instance, in U.S. Pat. No. 6,064,063 to Mickael having the same assignee as the present invention. Calibration may also be done using laboratory measurements on core data.

The processing of the measurements made in wireline applications may be done by the surface processor 33, by a downhole processor, or at a remote location. The data acquisition may be controlled at least in part by the downhole electronics. Implicit in the control and processing of the data is the use of a computer program on a suitable machine readable medium that enables the processors to perform the control and processing. The machine readable medium may include ROMs, EPROMs, EEPROMs, Flash Memories and Optical disks.

While the foregoing disclosure is directed to the specific embodiments of the invention, various modifications will be apparent to those skilled in the art. It is intended that all such variations within the scope and spirit of the appended claims be embraced by the foregoing disclosure.

What is claimed is:

1. An apparatus for evaluating an earth formation, the apparatus comprising:
(a) a tool conveyed in a borehole in the earth formation;
(b) a radiation source on the tool which controllably emits radiation into the formation, the radiation source including:
(A) a source of alpha particles,
(B) a target material that emits the radiation when targeted by the alpha particles, and
(C) a mechanical device which controllably shields the target material from the alpha particles; and
(c) at least one detector spaced apart from the source which detects radiation resulting from interaction of the emitted radiation with the earth formation.

2. The apparatus of claim 1 wherein the source of alpha particles comprises an actinide selected from the group consisting of (i) ²⁴¹Am, (ii) ²³⁹Pu, (iii) ²¹⁰Po, (iv) ²⁴⁴Cm, and (v) ²²⁶Rn.

3. The apparatus of claim 1 wherein the emitted radiation is at least one of the group consisting of (i) neutrons, and (ii) gamma rays.

4. The apparatus of claim 1 wherein the target material comprises a nucleus selected from the group consisting of (i) ⁹Be, (ii) ¹⁰B, (iii) ¹³C, (iv) ⁷Li, and (v) ¹⁹F.

5. The apparatus of claim 1 wherein the mechanical device comprises:
(i) a shielding material which absorbs the alpha particles, and
(ii) a motor which controllably moves a piece of the source material into the immediate proximity of the target material.

6. The apparatus of claim 5 wherein the motor further comprises a reciprocating linear motor.

7. The apparatus of claim 5 wherein the shielding material comprises stainless steel.

8. The apparatus of claim 1 wherein the mechanical device comprises:
(i) a first slotted shield and a second slotted shield made of a material which absorbs alpha particles, the first and second slotted shields interposed between the source and the target,
(ii) a motor which produces controllable relative motion between the first and second slotted shields.

9. The apparatus of claim 8 wherein slots of the first and second slotted shield are one of (i) substantially parallel to an axis of the tool, and (ii) substantially orthogonal to an axis of the tool.

10. The apparatus of claim 8 wherein the mechanical device further comprises a spring-mass system.

11. The apparatus of claim 8 wherein the controllable motion is selected from the group consisting of (i) linear motion, and (ii) rotary motion.

12. The apparatus of claim 1 further comprising a processor which determines from the detected radiation at least one of (i) a formation density, (ii) a formation porosity, and (iii) an elemental composition of the formation.

13. The apparatus of claim 1 wherein the tool is conveyed into the borehole on a conveyance device selected from (i) a wireline, (ii) a drilling tubular, and (iii) a slickline.

14. The apparatus of claim 1 wherein the at least one detector detects radiation selected from (i) neutrons, and (ii) gamma rays.

15. A method of evaluating an earth formation, the method comprising:
(a) conveying a tool having a source of alpha particles and a target material that emits radiation into a borehole when targeted by alpha particles;
(b) emitting radiation into the formation by controllably shielding the target material from alpha particles and
(c) detecting radiation resulting from interaction of the emitted radiation with the earth formation at at least one location spaced apart from the source of alpha particles

16. The method of claim 15 wherein the source of alpha particles comprises an actinide selected from the group consisting of (i) ²⁴¹Am, (ii) ²³⁹Pu, (iii) ²¹⁰Po, (iv) ²⁴⁴Cm, and (v) ²²⁶Rn.

17. The method of claim 15 wherein the emitted radiation is selected from the group consisting of (i) neutrons, and (ii) gamma rays.

18. The method of claim 15 wherein the target material comprises a nucleus selected from the group consisting of (i) ⁹Be, (ii) ¹⁰B, (iii) ¹³C, (iV) ⁷Li, and (v) ¹⁹F.

19. The method of claim 15 wherein the controllable shielding further comprises:
(i) using a shielding material which absorbs the alpha particles, and (ii) moving a piece of the source material into the immediate proximity of the target material.

20. The method of claim 19 wherein moving the source material further comprises using a reciprocating linear motor.

21. The method of claim 19 wherein the shielding material comprises stainless steel.

22. The method of claim 15 wherein the controllable shielding further comprises:
(i) interposing a first slotted shield and a second slotted shield made of a material which absorbs alpha particles between the source and the target, and
(ii) moving the first and second slotted shields relative to each other.

23. The method of claim 22 wherein slots of the first and second slotted shield are one of (i) substantially parallel to an axis of the tool, and (ii) substantially orthogonal to an axis of the tool.

24. The method of claim 22 wherein moving the shields relative to each other further comprises a spring-mass system.

25. The method of claim 22 wherein the movement is selected from the group consisting of (i) linear motion, and (ii) rotary motion.

26. The method of claim 15 further comprising determining from the detected radiation at least one of (i) a formation density, (ii) a porosity of the formation, and (iii) an elemental composition of the formation.

27. The method of claim 15 further comprising conveying the tool into the borehole on a conveyance device selected from (i) a wireline, (ii) a drilling tubular, and (iii) a slickline.

28. The method of claim 15 wherein the detected radiation is selected from the group consisting of (i) neutrons, and (ii) gamma rays.

29. A computer readable medium for use with In apparatus for evaluating an earth formation, the apparatus comprising:
(a) a tool conveyed in a borehole in the earth formation;
(b) a radiation source on the tool which controllably emits radiation into the formation, the radiation source including:
(A) a source of alpha particles,
(B) a target material that emits the radiation when targeted with the alpha particles, and
(C) a mechanical device which controllably blocks the alpha particles from targeting the target material; and
(c) at least one detector spaced apart from the source which radiation resulting from interaction of the emitted radiation with the earth formation;
the medium comprising instructions which enable a processor to determine from the detected radiation at least one of (i) a density of the formation, (ii) a porosity of the formation, and (iii) an elemental composition of the formation.

30. The medium of claim 29 further comprising at least one of (i) a ROM, (ii) an EPROM, (iii) am EEPROM, (iv) a flash memory, and (v) an Optical disk.
